(19) United States
(12) Patent Application Publication
(10) Pub. No.: US 2006/0012060 A1
(43) Pub. Date: Jan. 19, 2006

(54) Method for manufacturing microlens

(75) Inventor: Hironori Hasei, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/155,552

(22) Filed: Jun. 20, 2005

(30) Foreign Application Priority Data
Jul. 16, 2004 (JP) 2004-209863

(51) Int. Cl. B29D 11/00

(52) U.S. Cl. 264/1.38

(57) ABSTRACT

A method for manufacturing a microlens includes: ejecting a liquid drop containing a material for forming the microlens from a liquid drop ejection apparatus to make the liquid drop lands on a substrate; and waiting until a predetermined time elapses after the liquid drop has landed; and performing a curing treatment on the landed liquid drop.

### BACKGROUND OF THE INVENTION

1. Field of the Invention

The present invention relates to a method for manufacturing a microlens.

Priority is claimed on Japanese Patent Application No. 2004-209863, filed Jul. 16, 2004, the content of which is incorporated herein by reference.

2. Description of Related Art

Recently, optical devices having a number of miniature lenses known as microlenses have become available. Examples of such optical devices include, for example, a light-emitting apparatus having a laser, an optical interconnection for an optical fiber, or a solid-state imaging element having a condenser lens for gathering incident light, or the like.

The use of an ink jet method as a method for manufacturing such a microlens has been sought. In this method, liquid drops containing a material for forming microlenses are ejected on a substrate from miniature nozzles provided in an ink jet head, and are then cured to form microlenses (for example, see Japanese Unexamined Patent Application, First Publication No. 2003-240911). As a material for forming such microlenses, an ultraviolet curing or a thermosetting resin material or the like are used.

With the ink jet method, in order to prevent clogging of the miniature nozzles, the liquid material that can be ejected should be one having a relatively low viscosity of 50 cps (mPa.s) or less. The inkjet method has the following problem: when liquid drops are irradiated with ultraviolet light or heated in order to cure the liquid drops immediately after such a low viscosity resin material is ejected, the diameters of the liquid drop may vary. Consequently, the diameters of the resulting microlenses will vary.

The variation in diameter is seen even when the material for forming microlenses does not contain organic solvent, and when most of constituent of the material is an ultraviolet curing resin material or a thermosetting resin material. Although the causes of the variance are not completely clear, it is believed that one of the causes is evaporation of polymerization initiator or monomers contained in the material for forming microlenses. It is also believed that another cause may be the elastic behavior of the ejected liquid drops when the liquid drops hit the substrate.

### SUMMARY OF THE INVENTION

The present invention was conceived in order to solve the above-mentioned problems, and an object thereof is to provide a method for manufacturing a microlens that can manufacture microlenses with high accuracy.

To achieve this object, the method for manufacturing a microlens according to the present invention includes ejecting a liquid drop containing a material for forming the microlens from a liquid drop ejection apparatus to make the liquid drop lands on a substrate; waiting until a predetermined time elapses after the liquid drop has landed; and performing a curing treatment on the landed liquid drop.

In the above-described method, the predetermined time preferably is a time after which a rate of change in a diameter of the liquid drop becomes smaller than a predetermined value.

In general, immediately after a liquid drop lands on a substrate, the diameter of the liquid drop decreases over time. It should be noted that although the diameter of a liquid drop is significantly reduced immediately after landing, the decrease in the diameter of a liquid drop is slowed down after considerable time elapses. Thus, the curing treatment is performed on a liquid drop after waiting until a predetermined time elapses after which the rate of change in a diameter of the liquid drop becomes smaller than a predetermined value. This can prevent a significant variance in the diameter of a liquid drop after curing due to slight difference in the timing when the curing treatment is performed. By this, microlenses can be formed with high accuracy, and it is possible to provide microlenses that exhibit excellent optical characteristics stably.

In the above-described method, the ejecting a liquid drop may include ejecting a plurality of liquid drops, the waiting until a predetermined time elapses may include waiting until the predetermined time elapses after the last liquid drop has landed, and performing a curing treatment includes performing the curing treatment on all of the liquid drops.

This can reduce the facility cost since the liquid drop ejection step and the curing treatment step may be separated.

In the above-described method, the curing treatment may be performed sequentially on each of the liquid drops ejected on the substrate at a predetermined time interval.

This enables effective performance of the liquid drop ejection step and the curing treatment step in a shorter time.

In the above-described method, preferably, the material of the microlenses is an ultraviolet curing resin material, and performing a curing treatment includes irradiating with ultraviolet light.

By this, the curing treatment can be performed on each liquid drop that is to be cured by irradiating ultraviolet light without affecting other liquid drops.

In the above-described method, the liquid repellency-imparting treatment is preferably performed on a region on the substrate other than a region to which a microlens is to be formed prior to ejecting the liquid drop.

By this, wetting and spreading of the liquid drop after it is made to land on the substrate is limited, and microlenses can be formed with even higher accuracy.

### BRIEF DESCRIPTION OF THE DRAWINGS

FIG. 1 is a schematic diagram illustrating a method for manufacturing a microlens and an apparatus for manufacturing the same according to this embodiment.

FIGS. 2A and 2B are schematic perspective views of a liquid drop ejection head.

FIG. 3 is a graph illustrating the relationship between elapsed time after a liquid drop lands and the diameter of a liquid drop.

FIG. 4 is a diagram illustrating shape of a liquid drop immediately after the liquid drop lands on a substrate and after a predetermined time elapses.

FIG. 5 is a diagram illustrating the liquid repellency-imparting treatment for the substrate.

FIG. 6 is a schematic view of a laser printer head.

### DETAILED DESCRIPTION OF THE INVENTION

Hereafter, various embodiments of the present invention will be described with reference to the drawings. In addition, in respective drawings used for the following description, the scale is changed for each member so that each member is of a size which can be depicted in the drawing.

Method for Manufacturing Microlens

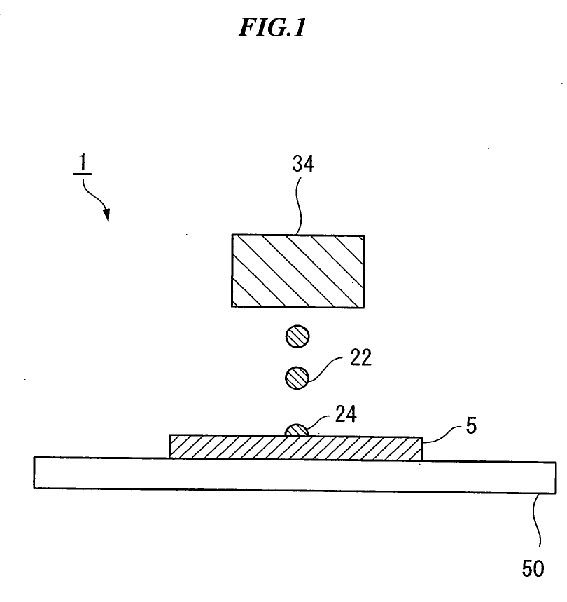

FIG. 1 is a schematic diagram illustrating a method for manufacturing a microlens and an apparatus for manufacturing the same according to this embodiment the method for manufacturing a microlens according to this embodiment includes ejecting a liquid drop containing a material for forming the microlens from a liquid drop ejection apparatus to make the liquid drop lands on a substrate; and waiting until a predetermined time elapses after the liquid drop has landed before performing a curing treatment on the landed liquid drop.

Material for Forming Microlens

As a material for forming microlenses, an optical transmitting resin is used. Specific examples include acrylic resins such as polymethylmethacrylate, poly hydroxyethyl methacrylate, poly cyclohexyl methacrylate; allyl resins such as poly diethylene glycol bisallyl carbonate or polycarbonates; methacrylic resins; polyurethane resins; polyester resins; polyvinyl chloride resins; polyvinyl acetate resins; cellulose resins, polyamide resins, fluoro resins; polypropylene resins; thermoplastic or thermosetting resins such as polystyrene resins. One of these resins may be used, or mixture of several of these resins may be used.

Non-solvent optically transparent resins are preferably used for this optical transmitting resin. Such non-solvent optically transparent resins are prepared by liquefying by diluting with a monomer thereof, for example, instead of dissolving the optically transparent resin in an organic solvent to liquefy the optically transparent resin, thereby making ejection from liquid drop ejection heads possible. In addition, the non-solvent optically transparent resin is made by adding a photo-polymerization initiator such as a biimidazole compound in the above optical transmitting resin, so that the resin can be used as a radiation curable type. In other words, addition of the photo-polymerization initiator provide the radiation curable resin with a radiation curable characteristic. Here, radiation is a general term which indicates various rays such as visible radiation, ultraviolet light, extreme ultraviolet light, X-rays, and electron beam, and among them, ultraviolet light is generally used.

Liquid Drop Ejection Head

The above-described lens material is ejected from a liquid drop ejection head.

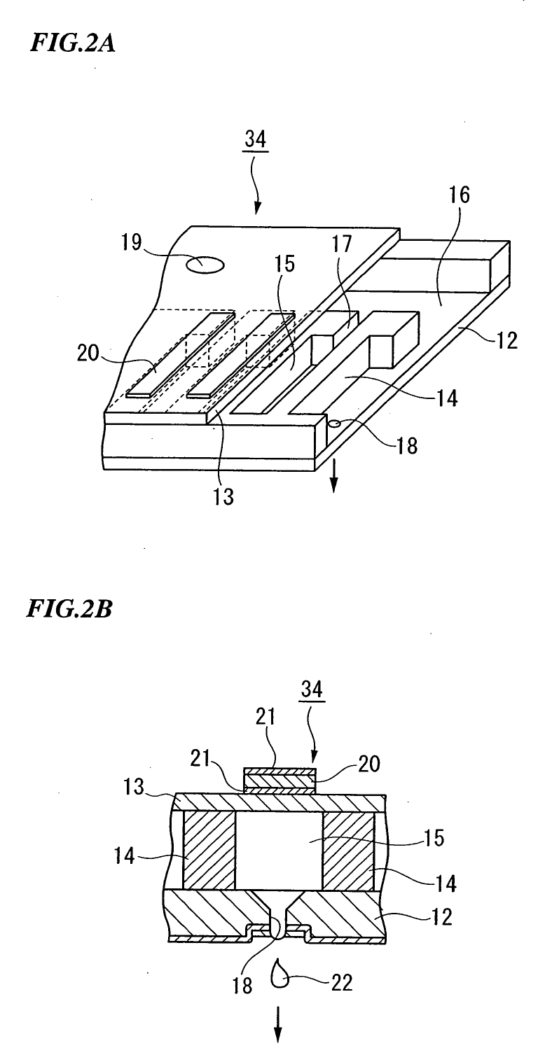

FIG. 2A is a schematic perspective view of a liquid drop ejection head, and FIG. 2B is a cross-sectional view of the liquid drop ejection head. The apparatus for manufacturing a microlens according to this embodiment includes a liquid drop ejection head 34 that ejects liquid drops containing a material for forming microlenses. As shown in FIG. 2A, this liquid drop ejection head 34 includes a nozzle plate 12 which is for example made of stainless steel, and a vibrating plate 13, and these are connected together via a partition member (a reservoir plate) 14. A plurality of cavities 15 and a reservoir 16 are defined between the nozzle plate 12 and the vibrating plate 13 by the partition member 14, and these cavities 15 and the reservoir 16 are communicated together via flow conduits 17.

Liquid material (material for lens) is filled within the interiors of these cavities 15 and the reservoir 16, and the flow conduits 17 between these have the function of acting as supply orifices which supply the liquid material from the reservoir 16 to the cavities 15. In addition, a plurality of hole-shaped nozzles 18 for ejecting the liquid material from the cavities 15 are formed in the nozzle plate 12 and are arranged in a vertical and horizontal array. On the other hand, a hole 19 is formed in the vibrating plate 13 so as to open within the reservoir 16, and a liquid material tank (not shown in the figures) is connected to this hole 19 via a tube (also not shown).

In addition, piezoelectric elements (piezo elements) 20 are connected to the surface of the vibrating plate 13 which is on the opposite side thereof from the surface which faces towards the cavities 15, as shown in FIG. 2B. These piezoelectric elements 20 are sandwiched between pairs of electrodes 21, and are made so as to flex towards the outside upon the application of electrical power.

The vibrating plate 13 with this structure, and to which the piezoelectric elements 20 are connected, is integral with the piezoelectric elements 20 and flexes towards the outside at the same time as each of them does, so that thereby the volumes of the corresponding ones of the cavities 15 are made to increase. When this occurs, if the interior of the cavities 15 and the interior of the reservoir 16 are communicated, and liquid material is charged into the reservoir 16, and then an amount of the liquid material which corresponds to the proportion by which the volume of the cavity 15 has increased flows from the reservoir 16 via the corresponding flow conduit 17 into that cavity 15.

In addition, when, in this state, supply of electrical power to the piezoelectric element 20 corresponding to that cavity 15 is cut off, the piezoelectric element 20 and the vibrating plate 13 both return to their original states together. Accordingly, the cavity 15 also returns to its original volume, so that the pressure of the liquid material in the interior of that cavity 15 rises, and the liquid material is ejected from the corresponding nozzle 18 as liquid drops 22.

Furthermore, as an ejecting device for the liquid drop ejection head 34, it would also be acceptable to utilize some device other than the above-described electro-mechanical conversion element employing the piezoelectric elements (piezo elements) 20; for example, it would also be possible to employ a method which utilizes an electro-thermal conversion element as the energy generation element, or a so-called continuous method of an electrification control type or of a pressure vibration type, or an electrostatic attraction method, or a method in which heat was generated in the liquid material by irradiating it with electromagnetic radiation from a laser or the like, and the liquid material was ejected by the action of this generated heat.

Also, it is preferable for the surface tension of the optically transparent resin used as the lens material to be within the range of greater than or equal to 0.02 N/m and less than or equal to 0.07 N/m. When ejecting an ink using a liquid drop ejection method, if the surface tension is less than 0.02 N/m, it becomes easy for deviations during ejection of the liquid drops to occur, since the wettability of the lens material with respect to the surface of the nozzle is increased. On the other hand, the surface tension exceeds 0.07 N/m, it becomes difficult to control the ejection amount and the ejection timing, since the shape of the meniscus at the nozzle tip becomes unstable.

In order thus to adjust the surface tension, it will be acceptable to add to the dispersion liquid of the above-described optically transparent resin, in very small amount, within the range in which the contact angle with the substrate does not greatly decrease, a surface tension modifier such as a fluorine-containing, a silicone-containing, or a non-ionic material, or the like. A non-ionic surface tension modifier increases the wettability of the lens material to the substrate, and improves the quality of leveling of the resulting layer, and is a material which serves to prevent the generation of minute concavities and convexities in this layer. It will also be acceptable, according to requirements, to include an organic compound such as an alcohol, an ether, an ester, a ketone or the like in the above-described surface tension modifier.

It is preferable for the viscosity of the optically transparent resin used as the material of lenses to be greater than or equal to 1 mPa.s and less than or equal to 200 mPa.s. When ejecting the ink as liquid drops using a liquid drop ejection method, if the viscosity is less than 1 mPa.s, the portion surrounding the vicinity of the nozzle can easily be contaminated by the liquid material as it flows out of the nozzle. In contrast, if the viscosity is greater than 200 mPa.s, ejecting the ink is made possible when a mechanism to heat the ink is provided to the head or the liquid drop ejection apparatus. However, it becomes difficult to eject liquid drops in a smooth manner because the hole in the nozzle may be frequently clogged at room temperature. If the viscosity is greater than 200 mPa.s, it is difficult to reduce the viscosity so that liquid drops are ejected even when the ink is heated.

Liquid Drop Ejection Step

The liquid drops of the lens material ejected from the liquid drop ejection head is made to land on a substrate.

As the substrate, a glass substrate or a semiconductor substrate, or one of such substrates to which a various functional thin film or functional element are formed, may be used. The surface of the substrate may be flat or curved, and the shape of the substrate is not particularly limited, and substrates with various shapes may be used.

For example, a GaAs substrate to which numerous surface emitting lasers are formed may be used as a substrate. In this case, in the vicinity of emitting end of each of the surface emitting lasers, an insulating layer (not shown) made of polyimide resin or the like is formed. Then, a base member is provided on a surface on the laser emitting side of each of the surface emitting lasers, and the liquid drops of the lens material are made to land on the base member to form a microlens. Here, as the material for forming the base member, it is preferable to utilize a material which has a light transparent characteristic, in other words, a material that absorbs virtually no light in a wavelength range of the light emitted from the surface emitting lasers. This material thus substantially transmits the emitted light. For example, polyimide resins, acrylic resins, fluoro-based resins, or the like may be preferably used, and in particular, polyimide resins are more preferable.

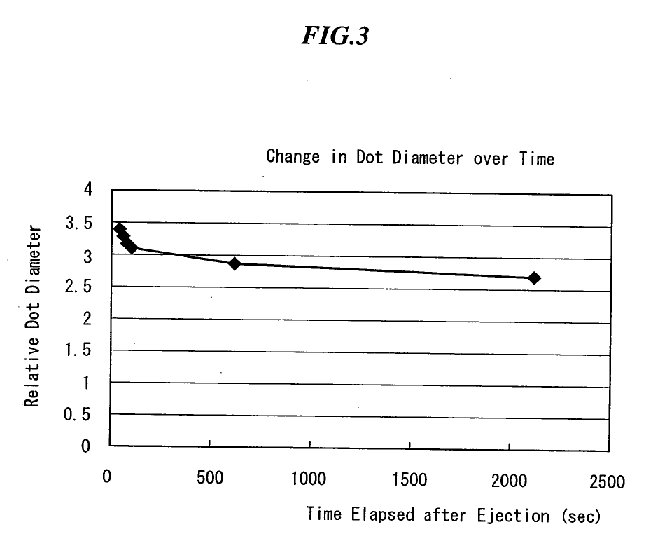

FIG. 3 is a graph illustrating the relationship between elapsed time after a liquid drop lands and the dot diameter (the diameter of a liquid drop).

FIG. 3 shows that immediately after a liquid drop lands on a substrate, the liquid drop shrinks over time, i.e., the diameter of a liquid drop is reduced. Furthermore, although the diameter of a liquid drop is sharply reduced immediately after landing (for example, until about 100 seconds after landing), the decrease in the diameter of a liquid drop is slowed down after considerable time elapses. This phenomenon occurs regardless of whether or not the lens material contains organic solvent, and it has been confirmed that it occurs even if most of constituent of the lens material is the ultraviolet curing or the thermosetting resin material.

It is believed that one of the causes is evaporation of polymerization initiator or monomers contained in the material for forming microlenses. That is, the diameter of a liquid drop is sharply reduced immediately after landing because of a high vapor pressure. After considerable time elapses, the decrease in the diameter of a liquid drop is slowed down because the vapor pressure drops. It is also believed that another cause may be the elastic behavior of the liquid drops when the liquid drops hit the substrate. FIG. 4 is a diagram illustrating shape of a liquid drop immediately after the liquid drop lands on a substrate and after a predetermined time elapses. As shown in FIG. 4, a liquid drop 28 is deformed in a compressed shape immediately after landing, and it gradually restores the semispherical shape to be a semispherical liquid drop 24 after a predetermined time elapses. As a result, the diameter of a liquid drop is decreased.

When a curing treatment is performed on liquid drops while the diameter of the liquid drops is sharply reduced, the diameter of a liquid drop after curing may significantly vary due to slight difference in the timing when the curing treatment is performed. This results in a significant variance in the diameter of microlenses, and accordingly, microlenses having excellent optical characteristics cannot be manufactured in a stable manner.

Thus, in this embodiment, the curing treatment is not performed on liquid drops until a predetermined time elapses after the liquid drop has landed on a substrate. This predetermined time is a time after which the rate of change in the diameter of a liquid drop (difference per unit time) becomes smaller than a predetermined value, and the rate of change can be calculated from the allowable size limit of the diameter of a microlens required to be formed. During this predetermined time, a substrate may be transferred from a liquid drop ejection stage to a curing stage, or no process is carried out on the substrate, as long as the curing treatment is not performed.

In this embodiment, with a close study on the variance in diameter of microlenses, the curing treatment is not performed until the rate of change in the diameter of a liquid drop becomes lower than a predetermined value. If the variance in other characteristics of a microlens than the diameter, such as the size, the shape, or physical properties, or the like, is studied, the curing treatment may not be performed until the rate of change of such characteristics, such as the size, the shape, or physical properties, or the like, of the liquid drop becomes lower than a predetermined value.

Curing Treatment Step

After the predetermined time elapses, a curing treatment is performed on the liquid drops. When an ultraviolet curing resin material is used as the lens material, ultraviolet light irradiation treatment is generally performed for the curing treatment, whereas heat treatment is generally used as the curing treatment when a thermosetting resin material is used for the lens material.

Liquid drops may be ejected on multiple locations on the substrate to form multiple microlenses. In this case, after all of the liquid drops are ejected after the predetermined time elapses, a curing treatment may be performed on all of the liquid drops. This can reduce the facility cost since the liquid drop ejection step and the curing treatment step may be separated.

Alternatively, a curing treatment may be performed respectively to each of multiple liquid drops. In this case, a curing treatment is performed sequentially on liquid drops in order of lapse of the predetermined time. The curing treatment may be performed sequentially with a predetermined time interval. This enables effective performance of the liquid drop ejection step and the curing treatment step in a shorter time. It should be noted that when an ultraviolet curing resin material is used as the lens material, the curing treatment can be performed on each liquid drop that is to be cured by irradiating ultraviolet light without affecting other liquid drops.

As described above, in the method for manufacturing a microlens according to this embodiment, a curing treatment is not performed on a liquid drop until a predetermined time elapses after the landing of the liquid drop. This predetermined time is a time after which the rate of change in the diameter of a liquid drop becomes smaller than a predetermined value. This can prevent a significant variance in the diameter of a liquid drop after curing due to slight difference in the timing when the curing treatment is performed. By this, the diameter of microlenses can be controlled with high accuracy, and it is possible to provide microlenses that exhibit excellent optical characteristics stably.

Liquid Repellency-Imparting Step

FIG. 5 is a diagram illustrating the liquid repellency-imparting treatment for the substrate. It is preferable to treat a region on the substrate 5 around a region 3 to which a microlens is to be formed prior to the liquid drop ejection step mentioned above with a liquid repellency-imparting treatment. As the liquid repellency-imparting treatment, for example, a method for forming a self-assembled film or plasma treatment or the like, may be used.

In the method for forming a self-assembled film mentioned above, on the surface of the substrate 5 above which an electrically conductive layer wiring pattern is formed, a self assembled layer 70 is formed from an organic molecular film or the like.

The organic molecular film for treating the surface of the substrate includes: a functional group which can be combined with the substrate 5; a functional group which modifies the quality of (i.e., controls the surface energy of) the surface of the substrate 5, i.e., a group having an affinity with liquid or a liquid repelling group positioned at the opposite side of the substrate-combining functional group; and a carbon straight chain which connects together these functional groups, or a carbon chain which branches off from one portion thereof; and it constitutes a molecular film, for example a monomolecular film, which is of the same constitution as the substrate 5, and is combined with the substrate 5.

As used herein, the term “self assembled layer 70” refers to a layer which consists of connecting functional groups which can react with the constituent atoms of the under-layer of the substrate 5 or the like and straight-chain molecules, and which is made by orienting a compound which has extremely high orientability due to interaction of its straight-chain molecules. Since such a self assembled layer 70 is made by orienting mono-molecules, it can be made extremely thin, and moreover it is a very uniform film at a molecular level. In other words, since all its molecules are positioned upon the same film surface, it has a very uniform film surface, as well as being able to impart an excellent liquid repellency or affinity with liquid.

As the above-described compound having high orientability, by using, for example, a fluoro alkyl silane, a self assembled film 70 is formed with the compounds being oriented so that the fluoro alkyl groups are positioned on the surface of the film, and so that a uniform liquid repellency is imparted to the surface of the film.

As compounds for forming the self assembled layer 70, there may be suggested fluoro alkyl silanes (hereinafter referred to as “FASs”) such as hepta-deca-fluoro-1,1,2,2-tetra-hydro-decyl-tri-ethoxy-silane, hepta-deca-fluoro-1,1,2,2-tetra-hydro-decyl-tri-methoxy-silane, hepta-deca-fluoro-1,1,2,2-tetra-hydro-decyl-tri-chloro-silane, tri-deca-fluoro-1,1,2,2-tetra-hydro-octyl-tri-ethoxy-silane, tri-deca-fluoro-1,1,2,2-tetra-hydro-octyl-tri-methoxy-silane, tri-deca-fluoro-1,1,2,2-tetra-hydro-octyl-tri-chloro-silane, tri-fluoro-propyl-tri-methoxy-silane, or the like. These compounds may be used alone, or in a mixture of two or more thereof.

It should be understood that, by using a FAS, it is possible to obtain both good adhesion to the substrate 5 and also the desired liquid repellency.

A FAS is generally expressed by the structural formula: RₙSiX₍₄₋ₙ₎, where n is an integer from 1 to 3 inclusive, and X is a methoxy group, an ethoxy group, a halogen atom or other hydrolytic group or the like. Furthermore, R is a fluoro alkyl group having a structure of (CF₃) (CF₂)ₓ (CH₂)_{y} (where x is an integer from 0 to 10 inclusive, and y is an integer from 0 to 4 inclusive), and, if a plurality of such Rs and/or Xs are combined with Si, it will also be acceptable either for the Rs and/or the Xs to be the same as one another, or alternatively for them to differ from one another. The hydrolytic groups which are expressed as X make a silanol by hydrolysis, and react with hydroxyl groups in the under-layer of the substrate 5 (glass or silicon) by forming a siloxane bond with the substrate 5. On the other hand, since R includes a fluoro group such as (CF₂) or the like upon its surface, it modifies the under surface of the substrate 5 into a non-wetting surface (whose surface energy is low).

The self assembled layer 70 made of an organic molecular film and the like is formed on the substrate 5 when the above-mentioned raw material compound and the substrate are contained in the same sealed container and left for two to three days at room temperature. Alternatively, the self assembled layer 70 is formed in about 3 hours when the entire sealed container is kept at a temperature of 100° C. It should be understood that, although in the above the formation of a self assembled layer 70 from the gas phase is used, such a layer could also be formed from a liquid phase. For example, the self assembled layer 70 may be formed on the substrate by soaking the substrate 5 in a solution which contains the source compound, cleaning it, and drying it.

In addition, it is desirable to perform pretreatment on the surface of the substrate 5 by irradiating with ultraviolet light, or by cleaning it by using a solvent before forming the self assembled layer 70.

In contrast, as plasma treatment method, a plasma processing method (a CF₄ plasma processing method) is preferably used in which tetrafluoromethane is employed as the process gas at ambient atmospheric pressure. As one example of conditions under which such CF₄ plasma processing may be performed, for example, the plasma power may be 50 to 100 W, the flow rate of the tetrafluoro methane (CF₄) gas may be from 50 to 100 ml/min, the relative shifting speed of the substrate 5 with respect to the plasma discharge electrode may be 0.5 to 1020 mm/sec, and the temperature of the substrate may be 70° C. to 90° C. It should be understood that the process gas should not be considered as being limited to tetrafluoro methane (CF₄); alternatively, it would be possible to utilize some other fluorocarbon gas. By performing this type of liquid repellency-imparting step, fluorine-containing groups are introduced into the surface of the substrate 5, and thereby a high liquid repellency is imparted.

As described above, by ejecting liquid drops 24 on a region to which a microlens is to be formed after providing a liquid repellency-imparting treatment around the region to which a microlens is to be formed, it is possible to limit wetting and spreading of the liquid drops 24. In this way, microlenses can be formed while controlling the diameter thereof further precisely.

Furthermore, as shown FIG. 4, the shape of the liquid drop 24 that has been irradiated with ultraviolet light is closer to a sphere than that of the liquid drop 28 immediately after landing. A microlens that is shaped closer to a sphere has a shorter focal length. The size of an optical device can be reduced by manufacturing the optical device using a microlens having a short focal length.

Laser Printer Head

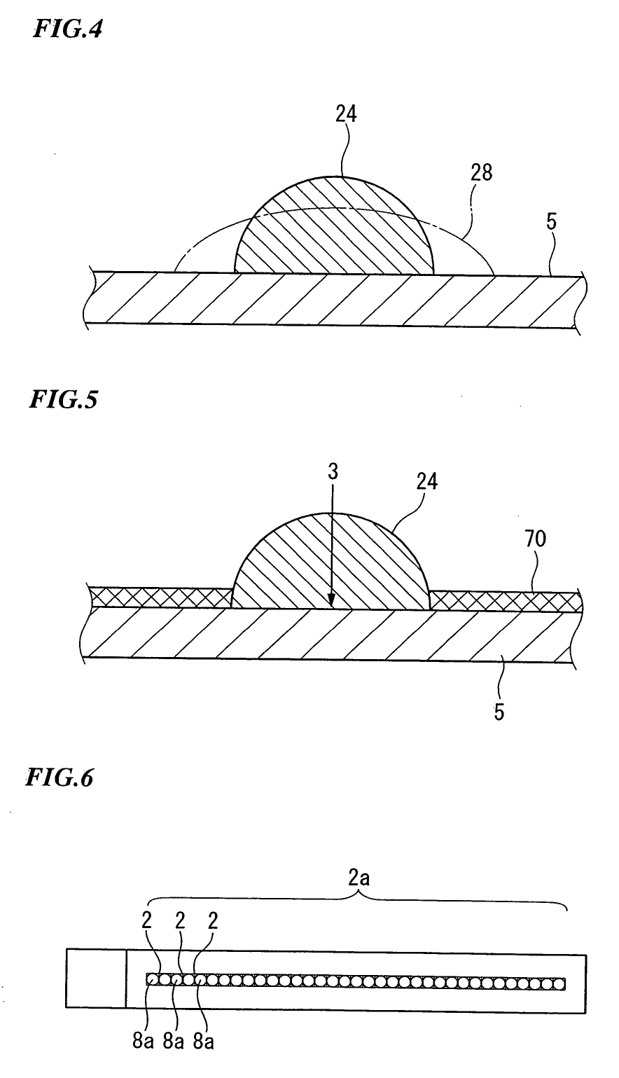

FIG. 6 is a schematic view of a laser printer head. The laser printer head shown in FIG. 6 includes microlenses manufactured by the method for manufacturing a microlens of this embodiment. The laser printer head includes, as an optical device, a surface emitting laser array 2a that is formed by arranging a number of surface emitting lasers 2 in a line, and microlenses 8a that are provided for each of the surface emitting lasers 2 forming the surface emitting laser array 2a. It should be noted that a driving element (not shown), such as a TFT, is provided for the surface emitting lasers 2, and a temperature compensating circuit (not shown) is provided for the laser printer head.

The laser printer head having such a structure is included in a laser printer.

Since such a laser printer head includes microlenses having excellent optical characteristics as described previously, the laser printer head exhibits a good image drawing capability.

Furthermore, since the laser printer includes such a laser printer head having good image drawing capability, the image drawing capability of the laser printer in turns is enhanced.

The technical scope of the present invention is not limited to the above-described embodiments; rather various changes can be made without departing from the spirit of the present invention.

For example, the microlens of the present invention can be applied to various optical devices other than the examples described above. For example, the microlens may be used as an optical component used in a light receiving surface of a solid-state imaging element (CCD), an optical connections for connecting between optical fibers, an optical transmission apparatus, a screen for a projector, a projector system, or the like. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A method for manufacturing a microlens, comprising:
ejecting a liquid drop containing a material for forming the microlens from a liquid drop ejection apparatus to make the liquid drop lands on a substrate;
waiting until a predetermined time elapses after the liquid drop has landed; and
performing a curing treatment on the landed liquid drop.

2. The method for manufacturing a microlens according to claim 1, wherein the predetermined time is a time after which a rate of change in a diameter of the liquid drop becomes smaller than a predetermined value.

3. The method for manufacturing a microlens according to claim 1, wherein the ejecting a liquid drop comprises ejecting a plurality of liquid drops, the waiting until a predetermined time elapses comprises waiting until the predetermined time elapses after the last liquid drop has landed, and the performing a curing treatment comprises performing the curing treatment on all of the liquid drops.

4. The method for manufacturing a microlens according to claim 1, wherein the curing treatment is performed sequentially on each of the liquid drops ejected on the substrate with a predetermined time interval.

5. The method for manufacturing a microlens according to claim 1, wherein the material of the microlenses is an ultraviolet curing resin material, and the performing a curing treatment comprises irradiating with ultraviolet light.

6. The method for manufacturing a microlens according to claim 1, wherein the liquid repellency-imparting treatment is performed on a region on the substrate other than a region to which a microlens is to be formed prior to ejecting the liquid drop.
